(19) United States
(12) Patent Application Publication
(10) Pub. No.: US 2006/0046204 A1
(43) Pub. Date: Mar. 2, 2006

(54) Directly patternable microlens

(75) Inventors: Yoshi Ono, Camas, WA (US); Wei-Wei Zhuang, Vancouver, WA (US); Wei Gao, Vancouver, WA (US); Bruce D. Ulrich, Beaverton, OR (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/931,596

(22) Filed: Aug. 31, 2004

(51) Int. Cl. G02B 3/00

(52) U.S. Cl. 430/321

(57) ABSTRACT

A method of forming a microlens structure using a patternable lens material is provided. An organic-inorganic hybrid polymer comprising titanium dioxide is exposed to light using a defocused mask image and then developed to produce a lens-shaped region.

### BACKGROUND OF THE INVENTION

The present method relates to methods of forming microlens structures on a substrate.

Increasing the resolution of image sensors requires decreasing pixel size. Decreasing pixel size reduces the photoactive area of each pixel, which can reduce the amount of light sensed by each pixel.

Positioning a microlens above each pixel may be used to increase the amount of light impinging on each pixel thereby increasing the effective signal for each pixel.

Current fabrication processes for forming microlenses use a number of steps to pattern a lens shape and then transfer the lens shape to the actual lens material to form the final lenses. This may be accomplished using a photoresist reflow method. For example, photoresist is patterned and reflowed to form bumps. A dry etch may then be used to transfer the lens-like bumps to an underlying lens material.

### BRIEF DESCRIPTION OF THE DRAWINGS

FIG. 1 is a cross-sectional view of a substrate prior to lens formation.

FIG. 2 is a cross-sectional view of a substrate during lens formation.

FIG. 3 is a cross-sectional view of a substrate during lens formation.

FIG. 4 is a cross-sectional view of a microlens structure overlying a substrate.

FIG. 5 shows transmission curves of a patternable lens material precursor.

FIG. 6 shows transmission curves for a patternable lens material after final bake.

FIG. 7 is a lens profile produced using an AFM.

### DETAILED DESCRIPTION OF THE INVENTION

A method is provided to form a microlens to increase the light impinging on each pixel of an active photodetector device. If the microlens is fabricated properly to provide the proper shape and position, the microlens will direct light impinging on the lens onto the photodetector pixel. If the microlens has an area larger than the pixel area, it can collect light that would normally impinge on the areas outside each individual pixel and direct the light onto the photodetector pixel. Increasing the amount of light impinging on the photodetector pixel will correspondingly increase the electrical signal produced by the pixel.

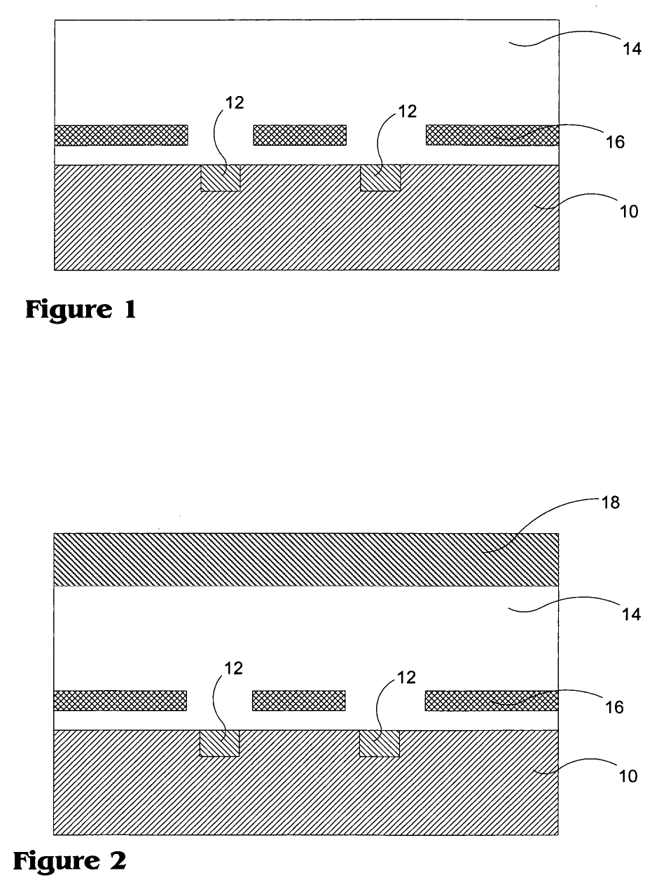

FIG. 1 shows photo-elements 12 at the surface of a substrate 10. The photo-elements 12 may be photosensitive elements, for example CCD, or CMOS, camera pixels; or photodisplay elements, for example LCD pixels. A transparent layer 14 has been deposited overlying the substrate 10. A metal layer 16 is shown overlying the substrate 10. The metal layer 16, and photo-elements 12 are provided for illustration purposes, as actual devices will have more detailed structures. Multiple metal layers 16 may be used for example.

A layer of patternable lens material 18 is then formed overlying the transparent layer 14 as shown in FIG. 2. The term “patternable lens material” refers to a material that can be patterned by exposing it to optical energy, developing it, and performing additional processes, if any, to convert the as-deposited material into a lens. The layer of patternable lens material 18 may be formed using a patternable lens material precursor, for example the precursor may be deposited by spin coating. In some cases, the pre-processing, such as a pre-bake may be desirable prior to patterning. The patternable lens material precursor may be a hybrid organic-inorganic coating material. Other potential patternable lens material precursors may include titanium acid solutions based on TiCl₄, or titanium alkoxide solutions based on titanium isoproxide.

The organic-inorganic hybrid material may comprise titanium dioxide. The hybrid organic-inorganic coating material may combine a polymeric titanium dioxide precursor with a compatible organic polymer in a glycol ether solution. A chelated organotitanate polymer is produced by chelating poly(n-butyltitanate), or PBT, to convert the tetracoordinate titanium nucleus into a hexacoordinate species. The chelated PBT and the organic polymer are dissolved in propylene glycol n-propyl ether in a desired metal oxide-to-polymer ratio. The final proportion of titanium dioxide above 70% may produce stress cracks during processing, however, increasing the titanium dioxide may increase the refractive index. The resulting solution is stirred for 4 hours at room temperature and then filtered through a 0.1 μm Teflon endpoint filter to remove particles before coating. Brewer Scientific, Inc. produces commercially available hybrid organic-inorganic coating materials suitable for use as patternable lens materials, for example OPTINDEX™ A14 high refractive index polymer.

A titanium acid solution may be produced by transferring TiCl₄ into a graduated dropping funnel under Ar atmosphere. The TiCl₄ is mixed with dichlormethane, and methacrylic acid is introduced to the resulting mixture. Water is slowly introduced with strong stirring, causing solid precipitates to form, and then dissolve as more water was introduced. A titanium precursor solution may then be extracted from the dichloromethane and washed with dichloromethane. The wash with dichloromethane may be performed multiple times, if desired. 2-methoxy ethanol or acetic acid may then be added into the extracted concentrated titanium precursor to produce a solution concentration suitable for spin coating.

A titanium alkoxide solution based on titanium isoproxide may be produced by mixing titanium isoproxide, water, iso-propanol and 2-methoxyethanol and stirring until white solids are precipitated, possibly approximately 4 hours. HCl is added to dissolve the white solid precipitates. Additional 2-methoxyethanol is then added to achieve a solution concentration suitable for spin coating. The resulting titanium alkoxide solution is then filtered to remove undesolved precipitates. A 0.2 μm filter may be used for example.

The patternable lens material precursor may be deposited using a spin-on process. For example, a layer of OPTINDEX™ A14 high refractive index polymer precursor is deposited in a single coat using spin-coating to a thickness of about 250 nm as shown in FIG. 2, by dispensing 3 ml of OPTINDEX™ A14 high refractive index polymer precursor over a 150 mm wafer at 700 rpm followed by 2000 rpm for approximately 1 minute. The patternable lens material may then be pre-baked. For example, the layer of OPTINDEX™ A14 high refractive index polymer precursor is pre-baked using a hot plate at a temperature of about 100° C. for approximately two minutes.

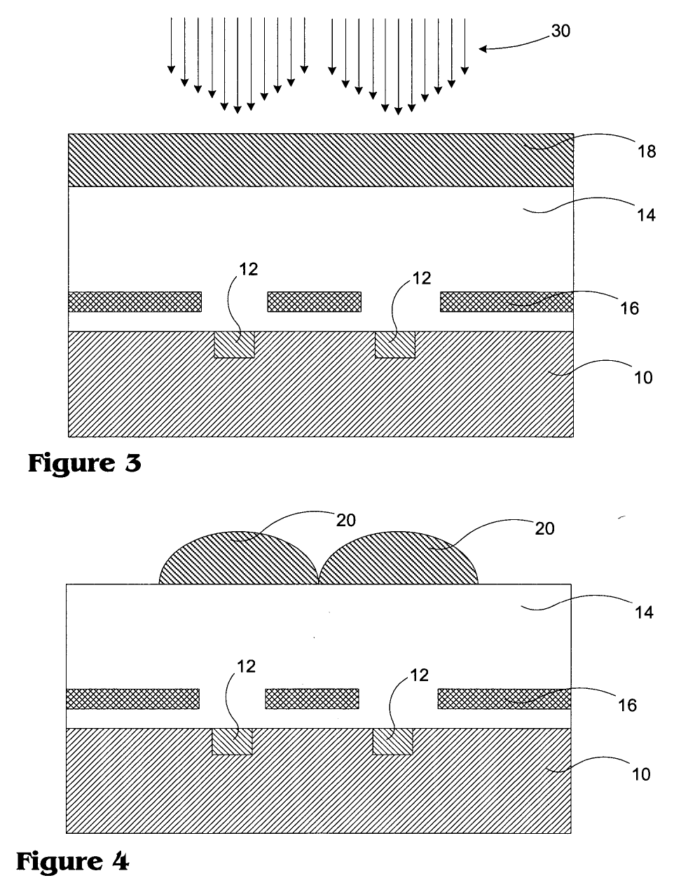

FIG. 3 shows the layer of patternable lens material 18 following pre-bake. The layer of patternable lens material 18 is exposed through a mask with the basic shape of a desired lens area, for example a circle. The layer of patternable lens material 18 can be exposed such that following developing a lens-shaped region is produced. Among the variables that can affect the patterning of the patternable lens material 18 are focus, exposure, reticle size, as well as developing conditions. The variables of focus, exposure and reticle design relate to the formation of the aerial image, which is the image of the reticle that is projected onto the layer of patternable lens material 18 by an optical system. The focus variable adjusts the contrast of the aerial image at the pattern edge. The exposure adjusts the pattern size of the final photoresist pattern laterally. The reticle design takes into consideration the overall pattern of the object as to proximity effects. As indicated by the arrows 30, by adjusting the focus and exposure the intensity of the exposure may not be uniform across the reticle pattern projected on to the layer of patternable lens material 18. This difference in intensity will harden the layer of patternable lens material 18 at different rates across the pattern projected. The term “harden” means that the material will be less susceptible to subsequent development processes following hardening. For example, using a circular mask opening, with a defocus will produce higher intensity at the center of the pattern and lower intensity at the edges of the pattern. A UV source may be used to expose the layer of patternable lens material 18. For example, the i-line of a conventional photolithography stepper may be used. The 365 nm UV radiation of the i-line at least partially hardens the layer of patternable lens material 18 where it is exposed. The total exposure times are significantly higher than that used for photoresist. For example, if OPTINDEX™ A14 high refractive index polymer precursor is used the exposure may be between approximately 0.4 watts/cm² and 36.0 watts/cm². The stepper can be set to produce an approximately 2 μm defocus to achieve the desired intensity gradient for a circular aperture of between approximately 1 μm and 3 μm. A lens diameter in excess of 10 μm may be achieved by increasing the defocus to greater than 10 μm defocus. Although an i-line of a stepper was used in the above example, a variety of other UV sources may be used. It may be possible to remove the i-line filter and use a broader spectrum from the Hg lamp used in the stepper. Other UV lamps, and UV laser sources, such as XeF, XeCl, KrF or ArF lasers, or solid-state UV lasers may be used for example. For some applications, non-UV sources may also be suitable.

Following the defocused exposure, the layer of patternable lens material 18 is developed. For example, if the layer of patternable lens material 18, which has been exposed, is OPTINDEX™ A14 high refractive index polymer precursor, it may be dipped in tetrahydrofuran (THF) for between approximately 10 seconds and 60 seconds, followed by an ultrasonic isopropyl alcohol (IPA) bath for approximately 5 minutes. The combined treatment of the unexposed portions of the layer of patternable lens material 18 with THF followed by ultrasonic IPA removes unwanted material leaving a lens-shaped region. A variety of alternative to the IPA rinse are available including rising with methanol, chloroform, or ethanol, for example. A final bake can then be used to complete the formation of microlenses 20 and increase the resulting index of refraction of the microlenses 20, as shown in FIG. 4. A final bake at between approximately 200° C. and 300° C. may be used. In some applications, the final bake temperature will be limited by the underlying device structures. In other applications, higher temperatures may be used.

Devoloping using THF and IPA may also be used to develop titanium acid solutions based on TiCl₄, or titanium alkoxide solutions based on titanium isoproxide, but the time may need to be adjusted, as well as the final bake temperature.

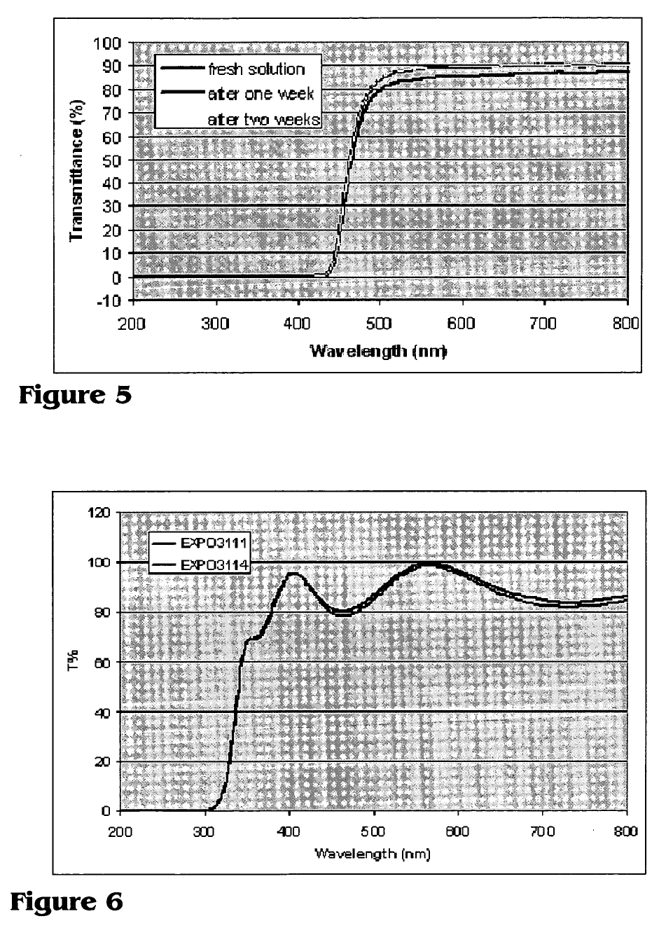

The OPTINDEX™ A14 high refractive index polymer precursor has a transmittance spectrum that is opaque from below about 450 nm and into the UV region, as shown in FIG. 5. Accordingly, UV exposure may be preferable to visible light exposure.

Following processing and final bake, the OPTINDEX™ A14 high refractive index polymer becomes quite transparent down to approximately 340 nm, as shown in FIG. 6. This implies that the OPTINDEX™ A14 high refractive index polymer may be self-limiting in that as the precursor absorbs UV radiation, at for example 365 nm, it becomes more transparent thereby reducing absorption and curing effects with continued exposure.

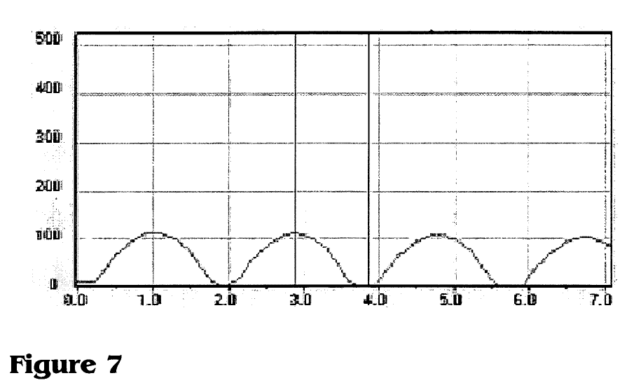

FIG. 7 shows a surface profile taken using an atomic force microscope (AFM). The final microlenses 20 are shown as approximately 100 nm thick, after developing and final bake of an initially approximately 250 nm thick layer of OPTINDEX™ A14 high refractive index polymer precursor. This final thickness should be considered when determining the resulting focal length of the resulting microlenses. This was formed using a single coating of OPTINDEX™ A14 high refractive index polymer precursor, it may be possible to produce thicker lenses by applying multiple coats during processing.

The substrate may be composed of any suitable material for forming or supporting a photo-element 12. For example in some embodiments, the substrate 10 is a silicon substrate, an SOI substrate, quartz substrate, or glass substrate.

In an embodiment of the present microlens structure, wherein it is desirable to concentrate light onto the photo-element 12, the transparent layer 14 will have a lower refractive index than each microlens 20. For example, if the transparent layer 14 has a refractive index of approximately 1.5, the microlenses 20 should have a refractive index greater than 1.5, preferably approaching or exceeding approximately 2. In other embodiments for use in display applications, for example, it may be desirable to form a lens with a lower refractive index than the transparent layer in order to diffuse rather than focus the light from each photo-element 12.

The thickness of the transparent layer 14 will be determined, in part, based on the desired lens curvature and focal length considerations. In one embodiment of the present microlens structure, the desired focal length of the microlenses 20 is between approximately 2 μm and 8 μm.

The terms of relative position, such as overlying, underlying, beneath are for ease of description only with reference to the orientation of the provided figures, as the actual orientation during, and subsequent to, processing is purely arbitrary.

Although embodiments, including certain preferred embodiments, have been discussed above, the coverage is not limited to any specific embodiment. Rather, the claims shall determine the scope of the invention.

What is claimed is:

1. A method of forming a microlens structure comprising:
forming a layer of patternable lens material overlying a transparent material;
exposing the patternable lens material using a predetermined focus and exposure to harden a lens-shaped region within the patternable lens material;
developing the patternable lens material leaving a hardened lens-shaped region; and
baking the hardened lens-shaped region to form a lens.

2. The method of claim 1, wherein the patternable lens material is formed using an organic-inorganic hybrid precursor material.

3. The method of claim 2, wherein the organic-inorganic hybrid precursor material comprises titanium dioxide components.

4. The method of claim 3, wherein the organic-inorganic hybrid precursor material comprises a chelated organotitanate polymer.

5. The method of claim 4, wherein the organic-inorganic hybrid precursor material comprises chelated poly(n-butyltitanate).

6. The method of claim 1, wherein the patternable lens material comprises titanium.

7. The method of claim 6, wherein the patternable lens material is formed using a precursor comprising a titanium alkoxide solution.

8. The method of claim 6, wherein the patternable lens material is formed using a precursor comprising a titanium acid solution.

9. The method of claim 1, wherein the predetermined focus is between 1 μm and 5 μm defocused.

10. The method of claim 5, wherein the predetermined focus is between 2 μm and 3 μm defocused.

11. The method of claim 1, wherein the lens has a higher refractive index than the transparent material.

12. The method of claim 11, wherein the transparent material comprises silicon dioxide or glass.

13. The method of claim 12, wherein the lens comprises TiO₂.

14. The method of claim 1, further comprising a photo-element located beneath the transparent material.

15. The method of claim 14, wherein the photo-element is a CCD pixel.

16. The method of claim 14, wherein the photo-element is an LCD pixel.

17. The method of claim 14, wherein the photo-element is an CMOS pixel.

18. A method of forming a microlens structure comprising:
exposing a lens-shaped region within an organic-inorganic hybrid polymer comprising titanium dioxide with UV light using a defocused mask image, developing the organic-inorganic hybrid polymer and baking the organic-inorganic hybrid polymer to form a lens.

19. The method of claim 18, wherein the predetermined focus is between 1 μm and 5 μm defocused.

20. The method of claim 19, wherein the predetermined focus is between 2 μm and 3 μm defocused.
